(19) United States
(12) Patent Application Publication
(10) Pub. No.: US 2020/0331695 A1
(43) Pub. Date: Oct. 22, 2020

(54) AUTONOMOUS STATUS MONITORING SYSTEM FOR GARBAGE BINS AND METHOD OF OPERATION

(71) Applicant: PSi Ecology Ltd, Ashdod (IL)

(72) Inventors: Avi RON, Ashdod (IL); Eyal RON, Liman (IL)

(73) Assignee: PSi Ecology Ltd, Ashdod (IL)

(21) Appl. No.: 16/957,733

(22) PCT Filed: Dec. 26, 2018
(86) PCT No.: PCT/IL2018/051392

§ 371 Date: Jun. 25, 2020

(30) Foreign Application Priority Data
Dec. 26, 2017 (IL) 256606

(51) Int. Cl. B65F 1/14; G16Y 40/10; G16Y 40/35; G16Y 20/10; G08B 25/10

(52) U.S. Cl. CPC B65F 1/14; G16Y 40/10; G08B 25/10; G16Y 20/10; G16Y 40/35

(57) ABSTRACT

A system and bin monitoring units are adapted to monitor the status of plurality of garbage bins and to collect bins status in a central service unit, to store and analyze the status of the garbage bins and to control the operation and collection travel plans of garbage field service units that comprise garbage collection trucks and garbage collection stuff.

### BACKGROUND OF THE INVENTION

Garbage collection, separation, transportation and recycling (or otherwise handling at the central garbage handling premises) involves with huge amounts collected garbage in even mid-scale towns which in turn requires thousands of travelled kilometers by garbage collection trucks which in turn increase pollution, traffic loads and noise nuisances. Even where domestic/home garbage s carefully separated the above disadvantages still exist.

There is a need for system and methods for reduction of the efforts, mobility, pollution and the like, which are involved in the course of garbage collection and removal from the city.

### SUMMARY OF THE INVENTION

A garbage bin monitoring unit (BMU) is disclosed comprising bin monitoring unit (BMU) equipment container, garbage volume detector, garbage bin water detector, controller unit, storage unit, communication unit and a battery.

In some embodiments the garbage bin monitoring unit further comprise temperature sensor for sensing and providing temperature indications inside the garbage bin, humidity sensor for sensing and providing humidity indications inside the garbage bin and movements sensing unit for sensing and providing indications of movements of the garbage bin.

A system for monitoring and controlling municipal garbage collection is disclosed comprising plurality of garbage bins (GBs) and plurality of garbage field service units (FSUs), the GBs provided, each, with bin monitoring units (BMUs), the system comprising a central service unit and a service management unit (403) for supporting central control of the system. The a central service unit comprising a controller, a storage unit having operating system and programs stored thereon and a communication unit for communicating with the plurality of BMUs and with the plurality of FSUs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a garbage bin with a bin monitoring unit (BMU) according to embodiments of the present invention;

FIG. 2 is a schematic partial isometric view of garbage disposal unit according to embodiments of the present invention;

FIGS. 3A and 3B are schematic isometric front view and back view of a BMU, respectively, according to embodiments of the present invention;

FIG. 3C is a schematic illustration of some major components of a BMU according to embodiments of the present invention; and

FIG. 4 is a block diagram of municipal garbage system operative with BMUs according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The examples described below relate to municipal garbage bins and garbage collection and disposal cases. It should be understood that same or similar system and methods may be used for management of large number of containers that are filled and emptied occasionally.

One large factor that causes large amount of undesired and unnecessary trips of garbage collection trucks is due to the fact that nowadays such trucks approach a specific garbage bin according to relatively rigid travel schedule that is not set according to the actual amount of garbage in the bins. As a result some bins may be emptied when their actual content is less than full, which means to many unnecessary travels of garbage trucks. In another situation the garbage truck may go to a bin that has already been flooded with too much garbage, which in turn cause unpleasant smell, air pollution and dirt in the streets. A well planned program for emptying city garbage bins should optimize between the number and lengths of travels associated with garbage removal from the streets and the risk of allowing some garbage bins to overflow with garbage. In order to enable this requirement the amount of garbage in each such bin should be measured and the measurements should be adapted to be collected and processed in order to provide a knowledge base for the city garbage collection program.

Another feature of this system should allow for monitoring of the status of the garbage bin, in order provide status info items such as: the actual volume/weight of garbage in the monitored bin, at any desired time; the amount of garbage at the time the bin is emptied; the amount of garbage left in the bin after it was emptied; the degree of dirt in the bin after it was emptied; the degree of dirt after the bin was autonomously been flushed (in systems that support this service).

In yet additional capability such system may be adapted to monitor, to automatically direct and to autonomously report of proper course of garbage separation or of a problem found during this process. Further such system may be adapted to continuously monitor the amount of each type of the separated garbage, thereby supporting even more efficient planning of garbage collection travels through the city. Still further this system may be adapted to communicate with a central service that may comprise storage means of the non-transitory kind, adapted to store data collected from plurality of garbage bins and to process this data in order to prepare optimized garbage collection plan, to issue warnings when abnormal and/or risky situation develop and to provide garbage collection data to the authorized officers of the city, that may allow them to endure that this crucial service is carried out as required.

The system may comprise one or more types of bin monitoring unit (BMU), that may be adapted to collect one or more data items indicative of the status of the bin, to store them and to transmit them to a central service where such data can be used for on-going monitoring of each of the serviced bins, for planning and—if needed—re-planning garbage collection travel schemes, for on-going monitoring of the garbage collection job, e.g. when the job is done by an outsource, for air quality monitoring in the vicinity of the bins, and the like. In some embodiments the system can be designed to operate at very low power consumption. For example, the system may be adapted to operate only at small time fractions and be turned into dormant mode at all other times, while being able to respond to external events that may occur during the dormant period. In some embodiments the low power mode may enable operation by power supplied by solar panel(s) and locally accumulated by batteries, thereby providing very long operational periods without needing human care for the power.

In some embodiments the system may prepare optimized collection travels of the trucks flee and may provide with it traveling directions based on proprietary or other applications.

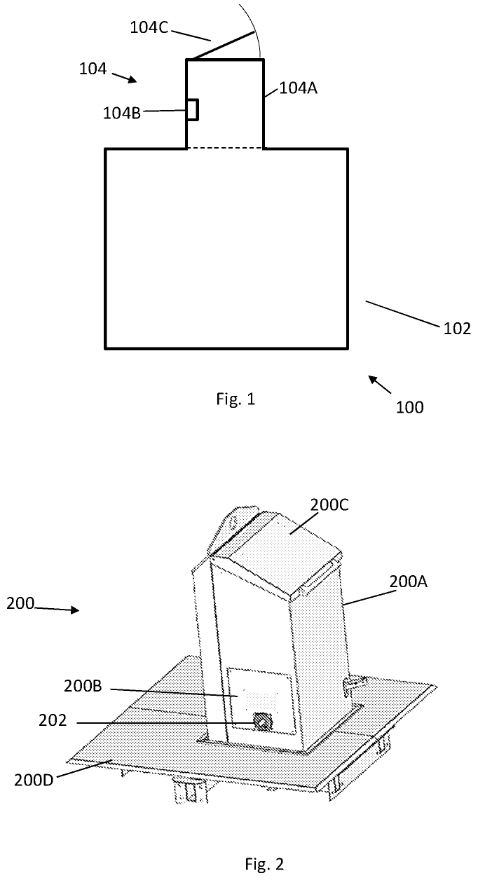

Reference is made now to FIG. 1, which is a schematic illustration of a garbage bin 100 with a bin monitoring unit (BMU) 104B, according to embodiments of the present invention. Garbage bin 100 may have garbage container 102 and garbage disposal unit (GDU) 104, typically on top of garbage container 102. Garbage disposal unit 104 is used for receiving garbage brought in relatively small packages or small amount by a person. GDU 104 may have cover 104C, operable manually, directly or indirectly, by the user. Cover 104C may be operated mechanically or electrically in response to proximity sensing device that identifies a user approaching garbage bin 100. GDU may have installed thereon, therein or close to it bin monitoring unit (BMU) 104B. BMU 104B may be installed in a way that will allow it to sense the events and physical variables it was made to sense without disturbances. For example, BMU 104B that is designed to continuously measure the amount of accumulating garbage in the container, and it uses ultrasonic (US) means for this measurement. In this case BMU 104B will be installed so that the transmitted US energy and the expected returning US energy usable to assess the amount of content in the container will have undisturbed space for their travel. If, in another embodiment, the measuring of the amount of content in the bin uses optical means BMU 104B will be installed so that the optical path from BMU 104B to the location of the bin's content will be free for the required optical images to be received. Similarly, BMU 104B may be installed to satisfy also additional requirements, such as protected from excessive moisture and mechanical hits, and the like. It will be understood that the location of BMU 104B in FIG. 1 is schematic only and is not binding.

According to some embodiments BMU 104B may be designed and adapted to be able to measure and/or monitor the following events or physical phenomena: momentary free space of container 102, temperature inside container 102 and outside of it, humidity inside (and optionally outside) container 102, movements of container 102 (by means of acceleration sensors or in other way), presence of water, signs of fire (smoke, etc.) and the like. According to some embodiments BMU 104B may be made of more than one physical units. For example BMU 104B may have one sub-unit installed inside the harsh environment within the internal volume of garbage bin 100 while another sub-unit may be installed outside of garbage bin 100, thereby exposing less elements o BMU 104B to threats typical to the inside of a garbage bin which enhances the service life of BMU 104B and reduces its costs of production and maintenance.

BMU 104B may further comprise local controller that is adapted to monitor and administer the operation of sensors in BMU 104B and to collect the information provided by them. BMU 104B may also comprise communication unit that is adapted to operate a wireless communication over a wireless channel or channels, as is known in the art, for example using cellular link, however the communication may be carried out using other means, protocols or providers. For example, communication via LoRa vs Zigbee, or other communication protocols, for example using gateway, may be used in other embodiments. The controller is adapted maintain active communication channel with the communication unit, for receiving queries sent from remote units, for receiving operational control and data sent from a remote operator and for sending to remote central service the data collected by BMU 104B. The data collected by BMU 104B may be sent as a raw data, or may first be processed—kind of local pre-processing—that may distribute the processing load and reduce communication load. Considerations regarding how the processing and communication loads will be distributed between BMU 104B and a remote service may be aimed, for example, for reducing the overall power consumption of BMU 104B.

In some embodiments BMU 104B may be powered by a battery that may be a rechargeable battery. The rechargeable battery may be recharged by a local solar panel. With careful design of the components of BMU 104B such solar panel may be small enough to be integrated in BMU 104B without causing substantial enlarging of the BMU 104B unit.

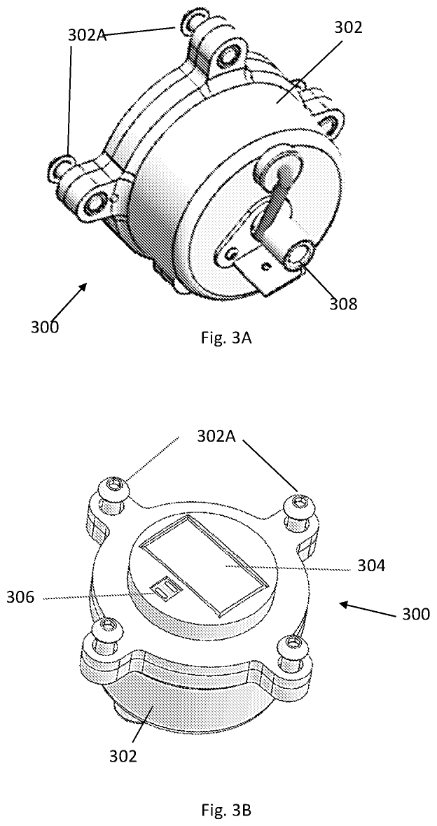

Reference is made now to FIG. 2, which is a schematic partial isometric view of garbage disposal unit 200, according to embodiments of the present invention. Garbage disposal unit (GDU) 200 is similar in functions to GDU 104. GDU 200 comprise BMU 202, which may be similar or equivalent to BMU 104B of FIG. 1. For practical reasons, such as ease of maintenance, BMU 202 may be installed on a removable plate 200B on the side face (or any other face—as fits the specific needs) of GDU 200, thereby enabling easy access, tuning and maintenance of BMU 202 without needing to disassemble the entire GDU 200.

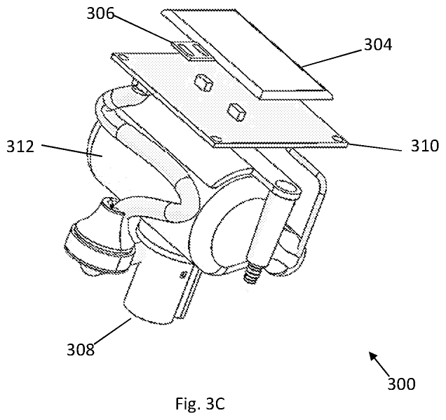

Reference is made to FIGS. 3A and 3B, which are schematic isometric front view and back view of BMU 300, respectively, according to embodiments of the present invention. BMU 300 may be contained in an equipment container 302, that may be compatible with high standards of weather resistance (e.g. humidity, UV radiation, water proof, etc.). BMU 300 may further include two or more installation means such as bolts 302A. BMU 300 may comprise, according to some embodiments, sensor 308, being a volume sensor, a humidity sensor and the like, may be located on the face of BMU 300 that will be installed facing into the monitored container. In some embodiments instead of placing volume sensor 308 directly on the inner face of BMU 300 it may be installable remotely from BMU 300, for example in order to enable locating the sensor 308 in an aggressive environment inside the container while placing the rest of BMU 300 away from that location. In such case sensor 308 may be connected by a respective cable and may be equipped with installation aids. On the outer face of BMU 300 a water sensor 308 may be installed, adapted, for example, to indicate whether the associated container was washed following its emptying. Further on the outer face of BMU 300 solar panel 304 may be installed so that it may be exposed to sun rays in day hours, in order to recharge an internal battery, or to directly power the system of BMU 300 in some embodiments. Other elements and functionalities of BMU 300 may be contained inside equipment container 302, such as a controller, a memory device, a battery, a communication unit, optionally an I/O unit for local testing and/or limited setting options.

Reference is made now to FIG. 3C, which is a schematic illustration of some major components of BMU 300, according to embodiments of the present invention. Inside equipment container 302 BMU 300 may comprise, additionally to the solar panel 304, the water sensor 306 and the volume or humidity sensor 308, battery 312 (such as a rechargeable battery), main electronic board 310 and additional components such as memory/data storage, I/O unit, communication unit and the like—which are not shown but may be embodied inside equipment container 302, as is known in the art.

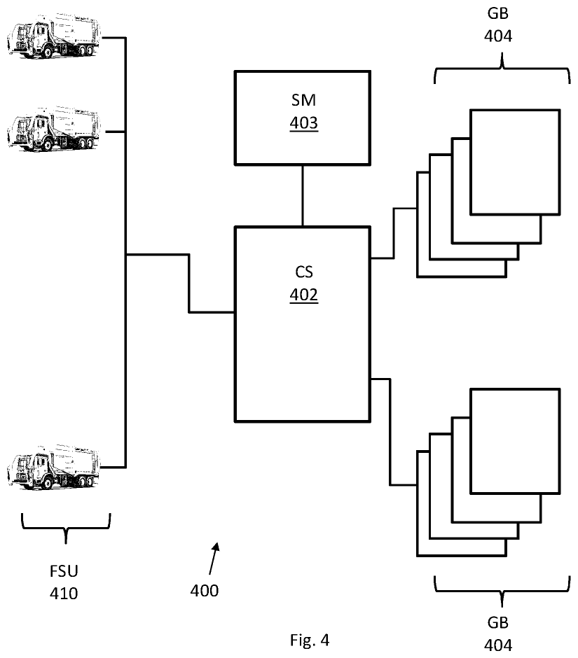

Reference is made now to FIG. 4, which is a block diagram of municipal garbage system 400 according to embodiments of the invention. System 400 may comprise central service (CS) 402, service management unit 403, plurality of garbage bins (GB) 404 and plurality of garbage field service (FS) units 410. Garbage bins 404 may be located in many locations at the municipal area, whether singles or in groups; whether adapted to receive general garbage (non-separated) or adapted to receive, each, only one kind of garbage items. Each of GB 404 is equipped with a BMU (bin monitoring unit) such as BMU 104B, BMU 202 or BMU 300. At least some of the BMUs are linked over a communication line with CS 402, for providing data indicative of events and values of physical variables at or near the respective GB, for receiving queries from CS 402 and for receiving data/configuration updates from CS 402. CS 402 may also be inactive communication with one or more municipal field service units (FSU) 410, which may comprise field staff and field vehicles (e.g. garbage collection truck). CS 402 may receive continuous information of the location of each FSU 410 and further information indicative of the progress of daily missions assigned to each FSU 410. The information exchanged between any of FSU 410 and CS 402 may be handled fully manually at the FSU 410 end, partially manually or fully automatically, depending mainly on the level of computation of the respective FSU 410.

CS 402 may comprise computation resources and data and programs storing resources, as is known in the art. CS 402 may further have, stored with its storage means, programs that when executed perform one or more of the following functionalities:
Receive from plurality of GB 404 data indicative of the momentary amount of content in the bin, the temperature and humidity in the bin, movements of the bin, whether the bin was washed with water, whether fire started in the bin, etc.
Manage records reflecting the lifetime, status, special events associated with the GB 404, and the like.
Continuously monitoring the amount of garbage in each GB 404, and planning garbage collection mission for one or more CSUs 410, so that the overall usage of CSUs 410 is optimized for minimal travel mileage, for ensuring that no GB 404 will overflow prior to its next garbage collection, for prioritizing garbage collection travels at hours of lower traffic loads, etc. These planning parameters may be controlled and set by an authorized user of system 400.
Monitoring special events and routine handling, such as providing alarms is fire has been detected or even if the temperature inside the bin exceeded a given preset temperature.
Receiving and managing routine handling of the GBs 404. For example—detecting whether a GB 404 that was just emptied was also washed according to a washing scheme. Emptying may be deduced based on movements indications followed by low/zero volume of content and washing may be deduced via water sensor.
Optionally monitoring the compliance of garbage separation with the separation rules, by receiving data indicative of the nature of garbage disposed in each given GB 404 and comparing this to the kind of separated garbage that GB 404 should be filled with. The nature of separated garbage may be detected using proper sensor(s), e.g. adapted to sense presence of glass, metal, cardboard, etc., as is known in the art.
Processing hazard situation and issuing respective warnings, to pre-set addressees that may be selected by an authorized user of CS 402.
Processing and providing to service management 403 analysis of the collected data in any desired data section, adapted to, for example, provide ahead service plans for the FSUs 410, advance maintenance plans for checking the GBs 404, improvements in the garbage collection schemes, etc., monitoring of the compliance of outsource operators of the FSUs 410, and the like.
Supporting remote updates to CS 402, to GBs 404 and to FSUs 410.
Providing travel directions to one or more of the FSU 410, when performing garbage collection mission.
Supporting time/date/event special times and controlling/enabling/disabling certain activities of system 400 or elements in it based on such special times.
Controlling placing a selected GB 404 in dormant state or in operative state.

It will be understood that the protocol for enabling communication between GBs 404 and SC 403, and between CS 403 and FSUs 410 may be any proper protocol known in the art, such as TCP/IP, over any available cellular or other wireless channel and the like. The processors, storage units and operating systems may be any known in the art that enable the functionalities described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A garbage bin monitoring unit (BMU) comprising:
a bin monitoring unit (BMU) equipment container;
a garbage volume detector;
a garbage bin water detector, configured to indicate whether the BMU equipment container was washed;
a movements sensing unit with an acceleration sensor, configured to sense and provide indications of movements of the garbage bin;
a controller unit;
a storage unit;
a communication unit, configured to wirelessly send data of the BMU to a remote server; and
a battery.

2. The unit of claim 1 further comprising:
a temperature sensor for sensing and providing temperature indications inside the garbage bin; and
a humidity sensor for sensing and providing humidity indications inside the garbage bin.

3. The unit of claim 1 further comprising:
an alarm unit adapted to:
signal an alarm situation on or in or close to the monitored garbage bin based on detection of hazard situations detected by the controller unit; and
send an alarm signal to a remote central service.

4. The unit of claim 3 wherein the communication unit is adapted to send indications received from one or more of the sensors and status of the garbage bin as processed by the controller unit, to a remote central service.

5. The unit of claim 1 further adapted to receive control signals from the remote central service so as to change its state between dormant state and operational state.

6. A system for monitoring and controlling municipal garbage collection comprising plurality of garbage bins (GBs) and plurality of garbage field service units (FSUs), the GBs provided, each, with bin monitoring units (BMUs), the system comprising:
a central service unit, comprising:
a central controller;
a central storage unit having operating system and programs stored thereon; and
a central communication unit for communicating with the plurality of BMUs and with the plurality of FSUs; and
a service management unit for supporting central control of the system,
wherein each BMU comprises:
a bin monitoring unit (BMU) equipment container;
a garbage volume detector;
a garbage bin water detector, configured to indicate whether the BMU equipment container was washed;
a movements sensing unit with an acceleration sensor, configured to sense and provide indications of movements of the garbage bin;
a controller unit
a storage unit
a communication unit, configured to wirelessly send data of the BMU to a remote server; and
a battery.
